(19) United States
(12) Patent Application Publication
(10) Pub. No.: US 2024/0349656 A1
(43) Pub. Date: Oct. 24, 2024

(54) AGRICULTURAL THINNING METHOD

(71) Applicant: SUN'AGRI, Paris (FR)

(72) Inventors: Benoît VALLE, Chazay d'Azergues (FR); Jean GARCIN, Montreuil (FR); Pauline LOEPER, LYON (FR); Perrine FORTIN, LYON (FR)

(21) Appl. No.: 18/687,748

(22) PCT Filed: Aug. 12, 2022
(86) PCT No.: PCT/EP2022/072637

§ 371 Date: Feb. 28, 2024

(30) Foreign Application Priority Data
Aug. 30, 2021 (FR) 2109023

(51) Int. Cl. A01G 7/06; A01G 3/08

(52) U.S. Cl. CPC A01G 7/06; A01G 3/08

(57) ABSTRACT

“A method is provided for thinning fruits (F) and/or flowers belonging to plants (A) located beneath orientable photovoltaic sensors (C), with the shade from the sun cast onto the plants being adjusted by changing the orientation of the sensors. In the method by virtue of the orientation of the sensors, the plants are kept in the shade for a sufficient duration to induce thinning by shading said plants from the sun.

### TECHNICAL FIELD

The present invention relates to agricultural thinning.

### PRIOR ART

Thinning involves reducing the number of plants from a seedling, flowers or fruit of a tree in order to promote the growth of the others. The aim is, for example, to control the load of a tree in order to provide a limited number of fruits. The trees will thus annually yield fruit exceeding the minimum market size, the annual production heterogeneities will be limited, i.e., production alternation, diseases will be reduced by spacing apart the fruit and the risk of breaking branches due to excess fruit will be reduced.

In conventional agriculture, it is common practice to use chemical thinning (post-floral) based on phytosanitary products. This type of thinning requires ideal meteorological conditions for proper application of the product and maximum efficiency. The effect is rapid, requiring the product to be applied with the correct dose at the correct stage of cultivation (limited time window) in order to cause the weaker fruit to fall.

In biological agriculture, it is common practice to use mechanical, pre-floral or post-floral thinning, generally without using a phytosanitary product.

It has been proposed for thinning by shading to be used, by entirely covering the trees with fairly opaque shading nets for a determined time interval in order to stimulate the abscission of the fruit or flowers. By thus significantly reducing (up to 80%) the light resource, the photosynthesis of the culture is affected, limiting the acquisition of carbon resources and therefore the ability to sufficiently feed all the fruit of the tree. However, fitting shading nets is relatively complex and expensive. The publication entitled, “Thinning apples by shading trees I. The efficacy of thinning”, by Katharina Kockerols, Albert Widmer, Michael Gölles and Esther Bravin, Agroscope Changins-WAdenswil ACW, 8820 WAdenswil, discloses results obtained by such a method.

The publication entitled, “Efficiency of fruitlet thinning in apple ‘Gala Must’ by use of Metamitron and artificial shading”, by Alina Basak, in the Journal of Fruit and Ornamental Plant Research, Vol. 19(1)2011: 51-62, describes a method for thinning apples combining the use of metamitron for inhibiting photosynthesis and the use of temporary artificial shading. The publication entitled, “Net Photosynthesis, Specific Leaf Weight, and Flowering of Peach as Influenced by Shade”, by Richard P. Marini and Donald L. Sowers, Department of Horticulture, Virginia Polytechnic Institute and State University, Blacksburg, VA 24061, discloses that the number of flowers from peach trees is linearly affected by the percentage of shading for the previous year during floral initiation, from June to July, without any impact after July 30^{th}.

The publications entitled, “Isolation and Characterization of genes associated with shade-induced apple abscission”, Chunjiang Zhou, Alan N. Lakso, Terence L. Robinson and Susheng Gan, Mol Genet Genomics (2008) 280:83-92, and “Individual and combined effects of shading and thinning chemicals on abscission and dry-matter accumulation of ‘Royal Gala’ apple fruit”, by S. Mcartney, M. White, I. Latter and J. Campbell, The Horticulture and Food Research Institute of New Zealand Ltd, Hawke's Bay Research Center, Private Bag 1401, Havelock North, New Zealand, Journal of Horticultural Science & Biotechnology (2004) 79(3) 441-448, relate to studies on the effects of thinning apples by shading and/or chemical thinning, notably on the production of the apples.

Moreover, agronomic models of plant growth such as Malusim (https://malusim.org/) exist for refining the detection of the time to apply the thinning chemical products.

### DISCLOSURE OF THE INVENTION

A requirement exists for thinning methods by shading to be further improved, notably in order to reduce their cost and to facilitate their implementation.

The aim of the invention is to meet this objective and, according to one of its aspects, the aim of the invention is a method for thinning fruits and/or flowers belonging to plants located beneath orientable photovoltaic sensors, with the shade from the sun cast onto the plants being adjusted by changing the orientation of the sensors, in which method, by virtue of the orientation of the sensors, the plants are kept in the shade for a sufficient duration to induce thinning by shading said plants from the sun.

Surprisingly, it has been found that photovoltaic sensors allow significant thinning by shading to be carried out despite the fact that they do not apply darkening comparable to the opaque shading nets as used in the aforementioned article by Kockerols et al.

The invention thus takes advantage of the presence of photovoltaic sensors in order to carry out thinning by shading, and therefore to obtain thinning without having to install shading nets or to apply phytosanitary products. In addition, since the sensors are already in place above the plants, it is then easy to apply the shade at the best time after flowering and just for the necessary duration, without being subjected to climatic risks during installation or needing labor for installing and removing the shading nets.

The invention also allows the method for thinning by shading to be easily automated by computer-controlling the photovoltaic sensors, whereas, in the prior art, thinning is a manual operation usually carried out by the agricultural operator. By virtue of the invention, the thinning can be controlled and stopped at any time by modifying, for example, the control of the photovoltaic sensors as soon as the shading objective is detected as being reached, unlike chemical thinning where the product acts all at once and where it is not possible to interrupt its action once it has been applied.

Once the shading aimed at achieving the desired thinning has been applied, the method can then comprise a phase in which, for a given period, on the contrary, the intention is to maximize the light applied to the plants by controlling the sensors in order to minimize shading, in order, for example, to promote the growth of the remaining fruit.

The invention allows the Treatment Frequency Index (TFI) to be reduced by using non-phytosanitary assistance for the thinning cultivation work.

The thinning according to the invention also can be implemented irrespective of the meteorological conditions, except in the event of a lack of direct radiation during the targeted cultivation period. The invention allows the applied shading to be more easily controlled in order to adapt it to the climatic conditions in real time.

In one embodiment, the orientation of the photovoltaic sensors is automatically computer-controlled in order to carry out the thinning action, notably at least based on data representing the number of fruit and/or flowers present and/or to be removed and/or the flowering or fructification state. These data can be obtained, for example, by automatic image analysis, with the images originating from one or more cameras allowing the plants to be observed.

Preferably, the shading applied to the plants during thinning is regulated at least according to the variety of the plant, the meteorological conditions, the initial load of the plant and the production objectives, notably the size classes of the fruit, the yield and/or the quality of the fruit.

In one embodiment, the desired abscission is caused while attempting to achieve an optimum maximizing the production of electrical energy as much as possible with respect to a reference not in combination with the plants.

The thinning method according to the invention can be carried out in addition to mechanical and/or chemical thinning. It is possible for the thinning method according to the invention to complete, for example, mechanical thinning, which occurs on earlier phenological stages (on the flowers) by acting on the fruit that is present in excess compared to the objectives of the producer.

The photovoltaic sensors can be oriented during said duration so as to generate as much shade as possible on the plants to be thinned. This is notably useful when the intention is to remove a maximum number of fruit or flowers.

As mentioned above, at least one camera is preferably used to acquire images of the plants, with an information processing unit automatically determining the appropriate time for applying shading based on these images.

An application for a mobile telephone or a camera can be used by an agricultural operator to notify control software of the flowering and/or fructification state of the plants, allowing the appropriate time for applying shading to be automatically determined based on these images. This application allows the user to qualitatively (phenological stage) and quantitatively (number of flowers and/or of fruit) describe the plant and to provide indications concerning the quantity of fruit and/or flowers to be thinned.

This mobile application can optionally use geolocation data, such that the geolocation information is used to control the photovoltaic sensors. The application can be configured to automatically geolocate the telephone or the camera. Preferably, information is provided concerning the flowering and/or fructification state of the plants while the telephone is in the vicinity of these plants, so as to allow geolocation of the plants for which information is provided concerning the state thereof.

In an alternative embodiment, the mobile application allows the operator to photograph the plant so that the image can be post-processed in order to automatically determine the flowering and/or fructification state. The photograph of the plant can be geolocated in order to allow the photovoltaic sensors to be controlled as a function of the geolocation information. Preferably, at least one photograph of the plants is taken with the mobile telephone or the camera, and this photograph is automatically analyzed in order to deduce at least one item of information therefrom concerning the flowering and/or fructification state, with the photograph preferably being geolocated.

The use of the camera and/or of the application for a mobile telephone or camera allows the thinning method to be automated and accuracy to be improved.

In an alternative embodiment, an agronomic plant growth model is used to determine when to apply the shading in order to obtain the desired thinning.

The shading can be triggered after full bloom.

In one embodiment, the photovoltaic sensors are positioned on a supporting structure at a suitable height with respect to the plants so as to allow shading thereof at a maximum range.

Preferably, the height of the supporting structure is adjustable. This allows the range of the desired shade to be adjusted.

The plants can be selected from among fruit trees, in particular apple trees, pear trees, plum trees, apricot trees, fig trees, actinidias, cherry trees and peach trees, and more generally all fruit trees with seeds and cores.

The invention can be implemented in order to reduce the number of fruit by at least 10% compared to a reference without shading, better still by at least 20%.

A further aim of the invention is a method for cultivating fruit beneath orientable photovoltaic sensors, wherein, if the number of fruit or flowers on the plants exceeds a predefined limit detrimental to the desired quality for the fruit, thinning is carried out by implementing the thinning method according to the invention, as defined above, and, if the existing or previous conditions mean that thinning by shading is not or is no longer desirable because the number of fruit or flowers already corresponds to the desired quantities, the sensors are controlled so as to minimize the shading applied to the plants during the period in which applying shading by the sensors would be likely to cause an undesirable thinning effect.

### BRIEF DESCRIPTION OF THE DRAWINGS

The invention will be better understood from reading the following detailed description of non-limiting embodiments thereof, and with reference to the appended drawings, in which:

FIG. 1 FIG. 1 schematically shows a system for controlling the orientation of a photovoltaic sensor according to the invention;

FIG. 2 FIG. 2 is a schematic view of an electrical energy generation system comprising photovoltaic sensors allowing implementation of the thinning method by shading according to the invention; and

FIG. 3 FIG. 3 is a view similar to FIG. 2 illustrating the modification of the orientation of photovoltaic sensors with a view to achieving a different thinning objective.

### DETAILED DESCRIPTION

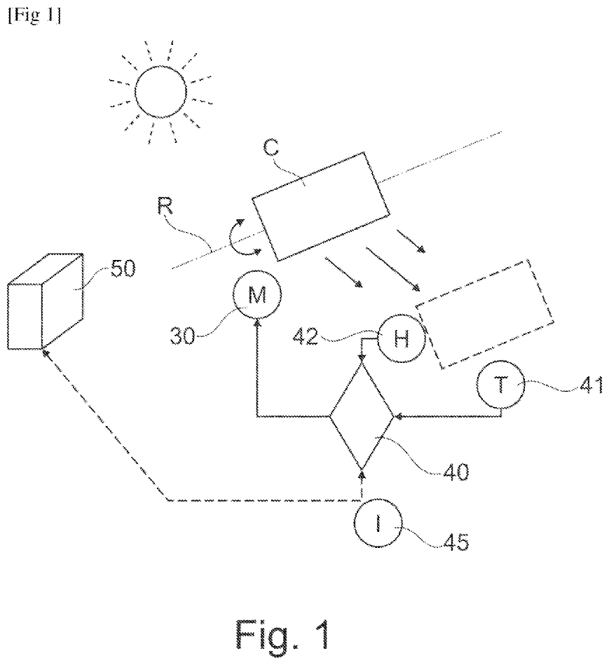

FIG. 1 schematically illustrates a photovoltaic sensor C that is movable about an axis of rotation R. The photovoltaic sensor C is pivoted about the axis R by means of at least one actuator 30. For example, an actuator 30 is individually provided for each photovoltaic sensor C. As an alternative embodiment, the same actuator 30 can rotate a plurality of photovoltaic sensors C.

The actuators 30 each comprise, for example, one or more electric motors, and are made up of servomotors, for example.

The position to be given to the photovoltaic sensor C can be determined by a local computer 40 that is connected to the actuator 30 via any suitable power interface.

The computer 40 preferably receives information from one or more local probes, for example, a temperature probe 41 and a hygrometry probe 42. Other probes can be added in order to scan the weather conditions, such as a rain gauge, an anemometer, and/or a camera 45 in order to acquire images and view the state of development of the plant, its initial load, the number of flowers and/or fruit present, and the flowering or fructification state, as well as one or more biosensors, where appropriate.

The computer 40 can also exchange data, for example, via a wireless telephone network, with a remote server 50, which can notify, for example, the computer 40 of the future weather conditions and/or can comprise an information processing unit automatically determining the appropriate time for applying the shading based on the images acquired by the camera 45.

The computer 40 can be made from any microcomputer or computer equipment for controlling the orientation of the photovoltaic sensors C as a function of one or more control laws providing the orientation to be imposed on the photovoltaic sensors as a function of data representing the number of fruit and/or flowers present and/or to be removed and/or the flowering or fructification state. The orientation to be imposed on the photovoltaic sensors C also can be controlled according to the variety of plants, the meteorological conditions, the initial load of the plant and the production objectives, notably the size classes of the fruit, the yield and/or the quality of the fruit.

The computer 40 can thus comprise a computation unit and a local memory that can store local data relating to the plants and/or their environment.

The memory of the computer can also comprise servo-control parameters that govern the orientation of the photovoltaic sensors C as a function of the production objectives. These parameters can evolve over time and, as a function of the season, for example, and may or may not favor the thinning of the plants by shading.

The one or more control laws can be initially programmed in the computer 40, or alternatively can be downloaded by the computer 40 from the remote server 50, or even can be periodically updated by the remote server 50.

In one embodiment, the computer 40 has autonomous operation. Depending on the season, the sowing date, the number of fruit and/or flowers present and/or to be removed and/or the flowering or fructification state, and optionally other parameters entered by the farmer, it controls the orientation of the photovoltaic sensors C automatically and daily, or following another schedule, so as to achieve the objective of thinning by shading over a given period. When the thinning method is implemented, the photovoltaic sensors C are oriented, for example, for several days in order to prevent light penetration as much as possible, generating as much shade as possible on the plants and also maximizing the electrical production. Then, once the desired abscission is achieved, the photovoltaic sensors C are, for example, set to an orientation, by activating the actuators 30, aimed at allowing maximum light penetration, to the detriment of the electrical production, for a given period, to allow the plants to make up for the delay in photosynthesis and to continue their development.

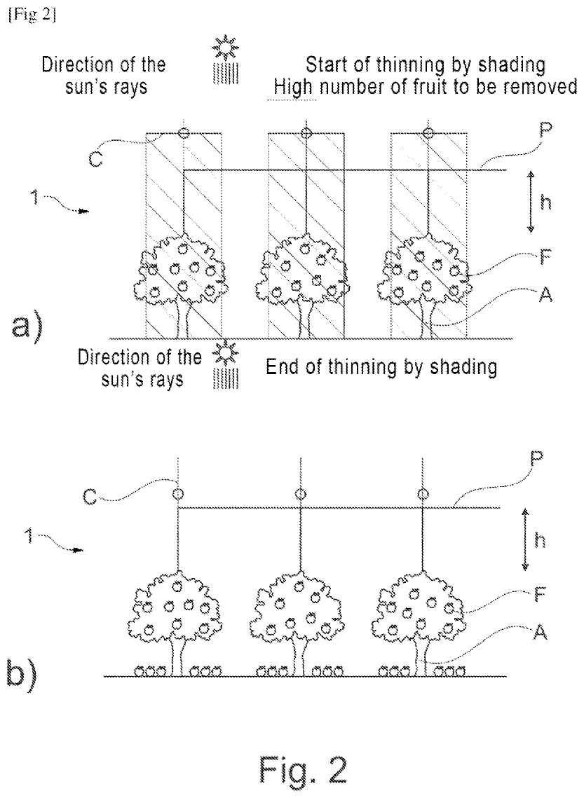

FIG. 2 schematically illustrates an electrical energy production system 1, comprising a supporting structure P and orientable photovoltaic sensors C kept at a non-zero distance from the ground by the supporting structure P, and at a height h from the fruit trees A, for example, pumps, located beneath the sensors C. The shade from the sun cast onto the plants is modified by changing the orientation of the sensors C.

FIGS. 2a) and 2b) respectively show the start and the end of the method for thinning by shading, with the objective being the abscission of a high number of fruit F. FIG. 2a) shows that the sensors C are oriented in a direction perpendicular to that of the rays of the sun, thus casting the maximum amount of shade onto the trees A. FIG. 2b) shows the end of the thinning where the sensors are oriented toward the rays of the sun in order to minimize the shade that is cast.

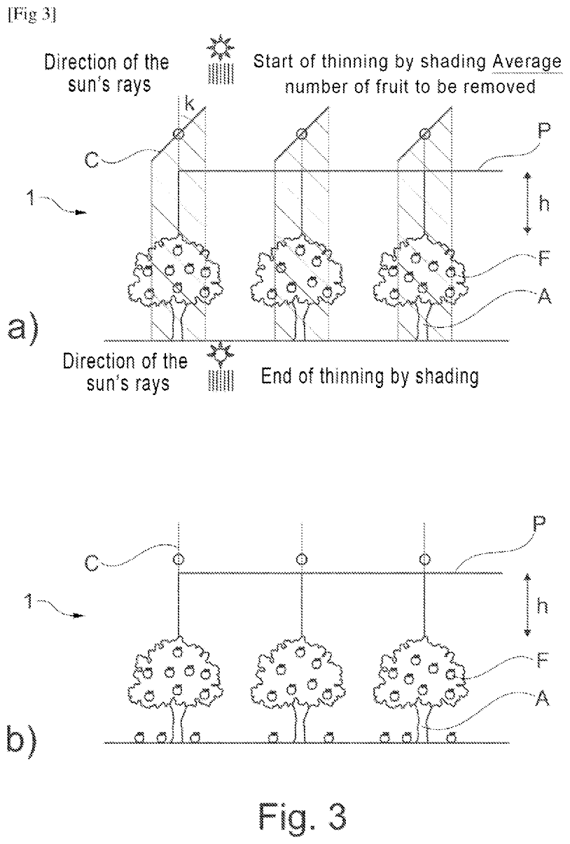

FIG. 3 is similar to FIG. 2, with the aim of removing less fruit F. To this end, at the start of the thinning operation, the sensors C form an angle k with the direction of incidence of the rays of the sun, as illustrated in FIG. 3a), thus casting less shade onto the trees A than in the previous situation. FIG. 3b) shows that, on completion of thinning, less fruit is removed, compared with the situation of FIG. 2. The method can use tables indicating the degree of shading to be applied as a function of the desired result, the variety and the stage of development of the fruit or flowers, for example. These tables can be stored and accessed by the computer 40 that controls the sensors C.

The invention is not limited to the embodiment described above. For example, thinning by shading can be implemented in conjunction with another thinning technique, for example, by applying a product.

1. A method for thinning fruits and/or flowers belonging to plants located beneath orientable photovoltaic sensors, with the shade from the sun cast onto the plants being adjusted by changing the orientation of the sensors,
said method comprising the steps of, by virtue of the orientation of the sensors, the plants are kept in the shade for a sufficient duration to induce thinning by shading said plants from the sun.

2. The method as claimed in claim 1, with the orientation of the photovoltaic sensors being automatically computer-controlled in order to carry out the thinning action.

3. The method as claimed in claim 1, with the shading applied to the plants during thinning being regulated at least according to the variety of the plant, the meteorological conditions, the initial load of the plant and the production objectives.

4. The method as claimed in claim 1, wherein the desired abscission is caused while attempting to achieve an optimum maximizing the production of electrical energy as much as possible with respect to a reference not in combination with the plants.

5. The method as claimed in claim 1, being carried out in addition to mechanical and/or chemical thinning.

6. The method as claimed in any claim 1, with the photovoltaic sensors being oriented during said duration so as to generate as much shade as possible on the plants to be thinned.

7. The method as claimed in claim 1, with at least one camera being used to acquire images of the plants, with an information processing unit automatically determining the appropriate time for applying shading based on these images.

8. The method as claimed in claim 1, with an application for a mobile telephone or a camera being used by an agricultural operator to notify control software of the flowering and/or fructification state of the plants.

9. The method as claimed in claim 8, wherein the application is configured to automatically geolocate the telephone or the camera, and wherein information is provided concerning the flowering and/or fructification state of the plants while the telephone is in the vicinity of these plants, so as to allow geolocation of the plants for which information is provided concerning the state thereof.

10. The method as claimed in claim 8, wherein at least one photograph of the plants is taken with the mobile telephone or the camera, and wherein this photograph is automatically analyzed in order to deduce at least one item of information therefrom concerning the flowering and/or fructification state, with the photograph preferably being geolocated.

11. The method as claimed in claim 1, wherein the shading is triggered after full bloom.

12. The method as claimed in claim 1, with an agronomic plant growth model being used to determine when to apply the shading.

13. The method as claimed in claim 1, with the photovoltaic sensors being positioned on a supporting structure at a suitable height with respect to the plants so as to allow shading thereof at a maximum range.

14. The method as claimed in claim 13, with the height of the supporting structure being adjustable.

15. The method as claimed in claim 1, with the plants being selected from among fruit trees.

16. A method for cultivating fruit beneath orientable photovoltaic sensors, wherein, if the number of fruit or flowers on the plants exceeds a predefined limit detrimental to the desired quality for the fruit, thinning is carried out by implementing the thinning method as claimed claim 1, and, if the existing or previous conditions mean that thinning by shading is not or is no longer desirable because the number of fruits or flowers already corresponds to the desired quantities, the sensors are controlled so as to minimize the shading applied to the plants during the period in which applying shading by the sensors would be likely to cause an undesirable thinning effect.
